(19) United States
(12) Patent Application Publication
(10) Pub. No.: US 2009/0151207 A1
(43) Pub. Date: Jun. 18, 2009

(54) PHOTOCARDS

(76) Inventor: Tuesday S. Hambric, Forney, TX (US)

Correspondence Address: MICHAEL A. O'NEIL, P.C., 5949 SHERRY LANE, SUITE 820, DALLAS, TX, 75225, US

(21) Appl. No.: 12/326,655

(22) Filed: Dec. 2, 2008

Related U.S. Application Data
(60) Provisional application No. 61/013,118, filed on Dec. 12, 2007.

(51) Int. Cl. G09F 11/00

(52) U.S. Cl. 40/1

(57) ABSTRACT

A photocard for advertising and informing an individual and business of business related subject matter comprises a pictographic element disposed on a portion of the photocard wherein the pictographic element comprises an image related to a business, and an information set positioned adjacent to the pictographic element and disposed on a portion of the photocard wherein the information set comprises information related to the business shown in the pictographic element. Additionally, a photocard for informing an individual of personally related subject matter comprises a pictographic element disposed on a portion of the photocard wherein the pictographic element comprises an image of an individual, and an information set positioned adjacent to the pictographic element and disposed on a portion of the photocard wherein the information set comprises information related to the individual depicted by the pictographic element.

### CROSS-REFERENCE TO RELATED APPLICATION

Applicant claims priority based on provisional patent application Ser. No. 61/013,118 filed Dec. 12, 2007, the entire content of which is incorporated herein by reference.

### BRIEF DESCRIPTION OF THE DRAWINGS

FIG. 1 is a diagram depicting an embodiment of the invention;

FIG. 2 is a diagram depicting another embodiment of the invention; and

FIG. 3 is a diagram depicting another embodiment of the invention.

### DETAILED DESCRIPTION

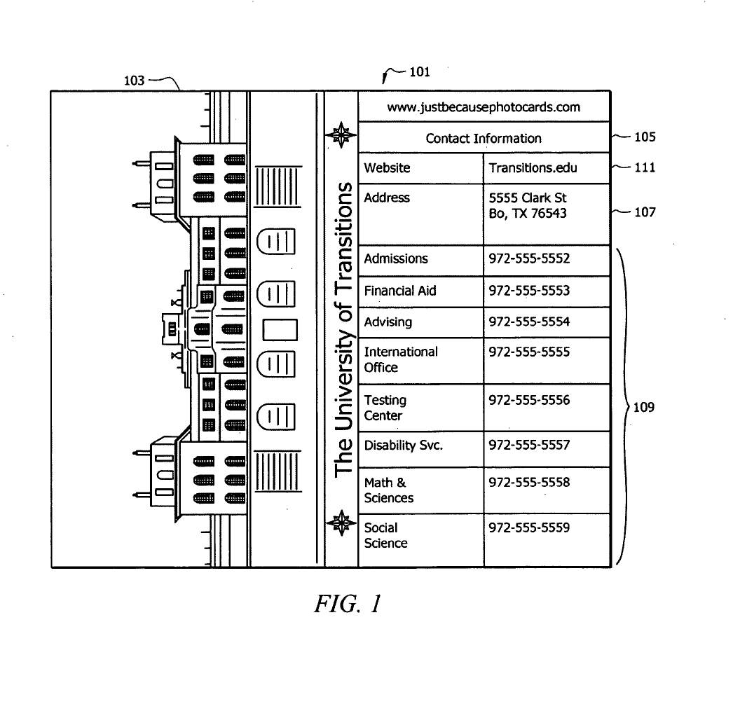

Referring to the drawings, and particularly to FIG. 1 thereof, an embodiment of a photocard 101 comprising the present invention is shown. The photocard 101 can be used for business purposes, such as for advertising or marketing of products or services, or for the identification of a business or an individual or group of individuals associated with the business, etc.

A pictographic element 103, such as a photograph, artist's rendering, computer generated image, or the like is disposed on a portion of the photocard 101. All types of images and manners of disposing an image on the photocard 101 are contemplated, such being known to those having skill in the art.

For example, the pictographic element 103 can depict the actual physical location of a business, such as the outside or interior of a building or other such structure; a landmark or skyline of a city or region in which the business is located; or an icon or logo, such as a trademark or service mark, associated with the business.

Alternatively, the pictographic element 103 can comprise an image of an individual or group of individuals. For example, a business may desire to display a photograph or other such rendering of an employee of the business on the photocard 101 so as to provide a customer or client of the business with the personal contact information of such individual, or to otherwise communicate information related to an individual's association with the business to a customer or client of the business.

If desired, multiple pictographic elements 103 can be disposed on the photocard 101. For example a business may desire to include an image associated with the business and also the image of an individual associated with the business on the same photocard 101. All conceivable numbers and combinations of pictographic elements 103, within the size limitations of the photocard 101, are contemplated.

The photocard 101 is also disposed with an information set 105. The information set 105 can contain information about the business, such as an address 107, various telephone numbers 109, e-mail addresses, website addresses 111, and facts and other information relevant to the business specifically, such as the founding date of the business, the number of employees employed by the business, achievements, honors, special recognitions, or distinctions condoned upon the business, educational or other achievements of employees, etc., or facts and other information relevant to the industry or field of the business in general. The items listed in the information set 105 are illustrative only. The information set 105 can contain any information desired by the user.

Alternatively, the information set 105 can comprise information about an individual or group of individuals, such as a team or division within a business. For example, the photocard 101 could contain the direct contact information, such as telephone number, e-mail address, individual website address, professional designations, information about how long the individual has been with the company and/or in the industry, the individual's title and role within the business, etc. of an individual shown in a pictographic element 103 of the photocard 101 and whose name appears on the photocard 101 as part of the information set 105.

The information set 105 can also contain information about a group of individuals, such as a team or division within the business. For example, information about the number of people within the team or division, the role and responsibility of the team or division within the business, contact information for the team or division, etc. could be included in the information set 105.

If desired, multiple information sets 105 can be disposed on the photocard 101. All conceivable numbers and combinations of information sets 105, within the size limitations of the photocard 101, are contemplated.

The pictographic element(s) 103 and information set(s) can be of any desired sizes respectively and can be disposed anywhere on the photocard 101 in relation to each other, so long as the pictographic element(s) 103 and information set(s) 105 are dimensioned so as to allow both to fit on the photocard 101.

The pictographic element(s) and information set(s) 105 can be disposed on the same side of the photocard 101 or on opposite sides of the photocard 101. Alternatively, the photocard 101 can be folded over any number of times so as to allow for the disposal of numerous or larger pictographic elements 103 and information sets 105. Referring to FIG. 1, the pictographic element 103 and information set 105 are shown in the same plane, however, FIG. 1 contemplates that the pictographic element 103 could be disposed on one side of the photocard 101 and the information set 105 could be disposed on the opposite side of the photocard 101.

The photocard 101 can be of any size desired, as long as it is large enough to contain both the pictographic element(s) 103 and the information set(s) 105 and conveniently fit into a wallet or other such article. For example, the photocard 101 could be two inches wide by three inches long.

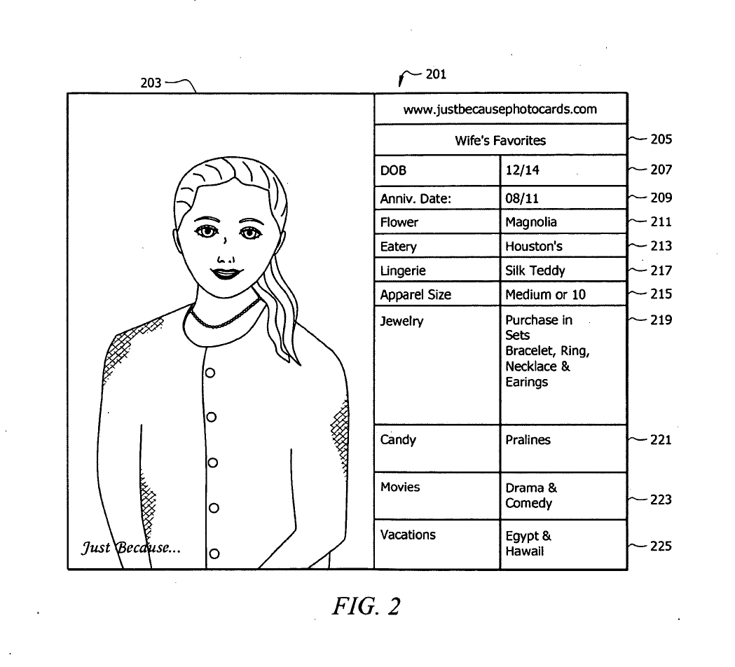

Referring now to FIG. 2, another embodiment of the invention 201 is shown. FIG. 2 relates to a photocard 201 that can be utilized for personal use.

A pictographic element 203, such as a photograph, artist's rendering, computer generated image, or the like is disposed on a portion of the photocard 201. All types of images and manners of disposing an image on the photocard 201 are contemplated, such being known to those having skill in the art.

The pictographic element 203 comprises an image of a loved one of the user or holder of the photocard 201, for example one's husband or wife, significant other, child, mother, father, brother, sister, etc. If desired, multiple pictographic elements 203 can be disposed on the photocard 201. All conceivable numbers and combinations of pictographic elements 203, within the size limitations of the photocard 203, are contemplated.

The photocard 201 is also disposed with an information set 205. The information set 205 can contain information about the individual(s) depicted by the pictographic element 203. For example, information such as the birth date 207, anniversary date 209, favorite food, favorite flower 211, favorite restaurant or bar 213, clothing sizes 215, favorite clothing styles, designers, or brands 217, favorite stores, such as clothing or jewelry stores, favorite types or pieces of jewelry 219, favorite foods 221, favorite movies or music or types of movies or music 223, favorite vacation sites 225, etc. can be included in the information set 205. The items listed in the information set 205 are illustrative only. The information set 205 can contain any information desired by the user.

The pictographic element(s) 203 and information set(s) 205 can be of any desired sizes respectively and can be disposed anywhere on the photocard 201 in relation to each other, so long as the pictographic element(s) 203 and information set(s) 205 are dimensioned so as to allow both to fit on the photocard 201.

The pictographic element(s) 203 and information set(s) 205 can be disposed on the same side of the photocard 201 or on opposite sides of the photocard 201. Alternatively, the photocard 201 can be folded over any number of times so as to allow for the disposal of numerous or larger pictographic elements 203 and information sets 205. Referring to FIG. 2, the pictographic element 203 and information set 205 are shown in the same plane, however, FIG. 2 contemplates that the pictographic element 203 could be disposed on one side of the photocard 201 and the information set 205 could be disposed on the opposite side of the photocard 201.

The photocard 201 can be of any size desired, as long as it is large enough to contain both the pictographic element(s) 203 and the information set(s) 205 and conveniently fit into a wallet or other such article. For example, the photocard 201 could be two inches wide by three inches long.

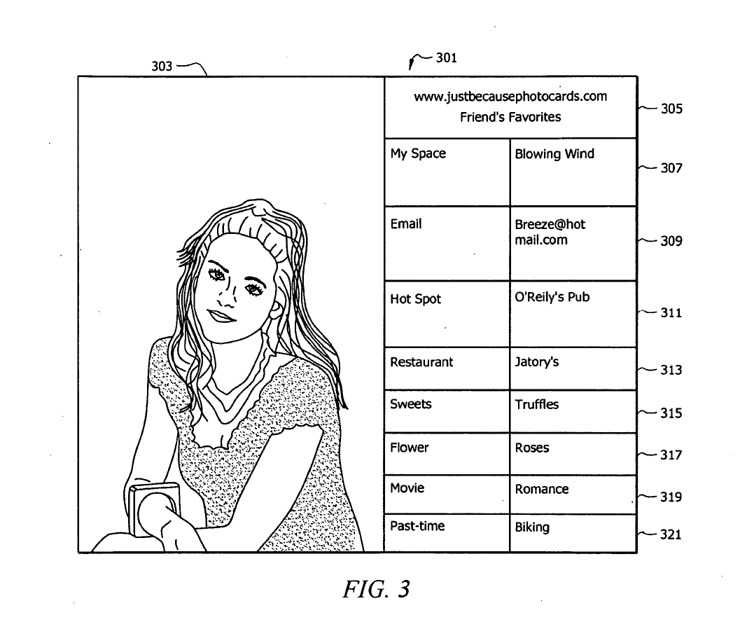

Referring now to FIG. 3, another embodiment of the invention is shown. FIG. 3 relates to an additional photocard 301 that can be utilized for personal use. For example, the photocard 301 could be exchanged by individuals who have just met for the first time, for instance as a bar, night club, restaurant, social event, etc., and wish to exchange contact and other such information. The photocard 301 could also be exchanged by friends or other acquaintances.

A pictographic element 303, such as a photograph, artist's rendering, computer generated image, or the like is disposed on a portion of the photocard 301. All types of images and manners of disposing an image on the photocard 301 are contemplated, such being known to those having skill in the art.

The pictographic element 303 can comprise an image of the individual using the photocard 301. The pictographic element 303 can comprise any image desired by the user, such as an image intended to express character or personality traits of the user. If desired, multiple pictographic elements 303 can be disposed on the photocard 301. All conceivable numbers and combinations of pictographic elements 303, within the size limitations of the photocard 301, are contemplated.

The photocard 301 is also disposed with an information set 305. The information set 305 can contain information about the individual depicted by the pictographic element 303 or about the user of the photocard 301. For example, information relating to the user's social networking medium, such as myspace.com®, etc. 307, e-mail address 309, favorite hot spot, bar night club, etc. 311, favorite restaurant 313, favorite sweet or candy 315, favorite flower 317 favorite movie 319, favorite past-time 321, etc. can be included in the information set 305. The items listed in the information set 305 are illustrative only. The information set 305 can contain any information desired by the user.

The pictographic element(s) 303 and information set(s) 305 can be of any desired sizes respectively and can be disposed anywhere on the photocard 301 in relation to each other, so long as the pictographic element(s) 303 and information set(s) 305 are dimensioned so as to allow both to fit on the photocard 301.

The pictographic element(s) 303 and information set(s) 305 can be disposed on the same side of the photocard 301 or on opposite sides of the photocard 301. Alternatively, the photocard 301 can be folded over any number of times so as to allow for the disposal of numerous or larger pictographic elements 303 and information sets 305. Referring to FIG. 3, the pictographic element 303 and information set 305 are shown in the same plane, however, FIG. 3 contemplates that the pictographic element 303 could be disposed on one side of the photocard 301 and the information set 305 could be disposed on the opposite side of the photocard 301.

The photocard 301 can be of any size desired, as long as it is large enough to contain both the pictographic element(s) 303 and the information set(s) 305 and conveniently fit into a wallet or other such article. For example, the photocard 301 could be two inches wide by three inches long.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

I claim:

1. A photocard for advertising and informing an individual and business of business related subject matter comprising:
at least one pictographic element disposed on a portion of the photocard wherein the at least one pictographic element comprises an image related to a business; and
at least one information set positioned adjacent to the at least one pictographic element and disposed on a portion of the photocard wherein the at least one information set comprises information related to the business shown in the at least one pictographic element.

2. The photocard for advertising and informing an individual and business of business related subject matter of claim 1 wherein the at least one pictographic element is a photograph.

3. The photocard for advertising and informing an individual and business of business related subject matter of claim 1 wherein the at least one pictographic element is an artist's rendering.

4. The photocard for advertising and informing an individual and business of business related subject matter of claim 1 wherein the at least one pictographic element is a computer generated image.

5. The photocard for advertising and informing an individual and business of business related subject matter of claim 1 wherein the at least one information set comprises business related information.

6. The photocard for advertising and informing an individual and business of business related subject matter of claim 1 wherein the at least one information set comprises information related to at least one employed individual within a business.

7. The photocard for advertising and informing an individual and business of business related subject matter of claim 1 wherein the at least one pictographic element and the at least one information comprise the same plane.

8. A photocard for informing an individual of personally related subject matter comprising:
at least one pictographic element disposed on a portion of the photocard wherein the at least one pictographic element comprises an image of an individual; and
at least one information set positioned adjacent to the at least one pictographic element and disposed on a portion of the photocard wherein the at least one information set comprises information related to the individual depicted by the at least one pictographic element.

9. The photocard for informing an individual of personally related subject matter of claim 8 wherein the at least one pictographic element comprises an image of a family member.

10. The photocard for informing an individual of personally related subject matter of claim 8 wherein the at least one pictographic element is a photograph.

11. The photocard for informing an individual of personally related subject matter of claim 8 wherein the at least one pictographic element is an artist's rendering.

12. The photocard for informing an individual of personally related subject matter of claim 8 wherein the at least one pictographic element is a computer generated image.

13. The photocard for informing an individual of personally related subject matter of claim 8 wherein the at least one information set comprises personal information.

14. The photocard for informing an individual of personally related subject matter of claim 8 wherein the at least one pictographic element and the at least one information set comprise the same plane.
